(19) United States
(12) Patent Application Publication
(10) Pub. No.: US 2015/0336816 A1
(43) Pub. Date: Nov. 26, 2015

(54) DRAW SOLUTES AND FORWARD OSMOSIS WATER TREATMENT APPARATUSES, AND METHODS USING THE SAME, AND METHODS OF PRODUCING DRAW SOLUTES

(71) Applicant: Samsung Electronics Co., Ltd., Suwon-si (KR)

(72) Inventors: Seung Rim YANG, Seongnam-si (KR); Bo Kyung JUNG, Yongin-si (KR); Won Cheol JUNG, Seoul (KR); Sung Soo HAN, Hwaseong-si (KR)

(21) Appl. No.: 14/665,085

(22) Filed: Mar. 23, 2015

(30) Foreign Application Priority Data
May 26, 2014 (KR) 10-2014-0063231

(51) Int. Cl. C02F 1/44; C08G 73/10

(52) U.S. Cl. CPC C02F 1/445; C08G 73/1092

(57) ABSTRACT

A draw solute may include a photosensitive oligomer that includes a first repeating unit and a second repeating unit. The first repeating unit includes a side chain having at least one functional group configured to undergo a photocrosslinking reaction. The second repeating unit includes an ionic moiety and a counter ion to the ionic moiety.

### CROSS-REFERENCE TO RELATED APPLICATION

This application claims priority under 35 U.S.C. §119 to Korean Patent Application No. 10-2014-0063231, filed in the Korean Intellectual Property Office on May 26, 2014, the entire contents of which is incorporated herein by reference.

### BACKGROUND

1. Field

Example embodiments relate to draw solutes, forward osmosis water treatment devices and methods using the same, and methods of producing draw solutes.

2. Description of the Related Art

Desalination using reverse osmosis is a known technique in the field of water treatment. Osmosis (or forward osmosis) refers to a phenomenon in which an osmotic pressure causes water to move from a solution of a lower solute concentration to a solution of a higher solute concentration. In the reverse osmosis process, a pressure higher than the osmotic pressure is artificially applied so as to drive water in the opposite direction, producing fresh water.

The reverse osmosis process consumes more energy as it requires the application of a relatively high pressure. To increase energy efficiency, a forward osmosis process using the principle of osmotic pressure has been suggested. In the forward osmosis process, a draw solution of a higher concentration than a feed solution is used to move water molecules toward the draw solution and then the draw solute is separated from the draw solution to produce fresh water. The separated draw solute is often reused. In the forward osmosis process, separation and recovery of the draw solute consume most of the energy expenses.

It is desirable for the draw solute to be easily removed from the treated solution and then reused. Examples of the currently available draw solute include a thermally decomposable (or a sublimatable) salt such as ammonium bicarbonate, a volatile solute such as sulfur dioxide, a soluble liquid or solid such as aliphatic alcohols and aluminum sulfate, sugars such as glucose and fructose, a polyvalent ionic salt such as potassium nitrate, magnesium chloride (MgCl₂), and magnesium sulfate (MgSO₄), and the like. Examples of the newly suggested draw solute include magnetic nanoparticles having a hydrophilic peptide attached thereto, a polymer electrolyte such as a dendrimer, and the like.

However, the foregoing draw solutes cannot be used for the process for producing drinking water or water for general household use. For example, the ammonium bicarbonate should be heated to at least about 60° C. to be vaporized, thus requiring higher energy consumption. Also, since complete removal of ammonia is relatively difficult, the treated water smells of the ammonia. The polyvalent ionic salts may generate high osmotic pressure, but during the forward osmosis process, its reverse salt flux toward the feed solution is very high and thus the loss of the draw solute is severe. In addition, as the polyvalent ionic salt generally has a low molecular weight, a high energy recovery process using a tight nanofilter membrane is inevitable. Moreover, most of the aforementioned draw solutes may exhibit considerable toxicity so that they may not be used in the forward osmosis process for producing drinking water. For example, in the case of the magnetic nanoparticles, it is relatively difficult to redisperse magnetic particles that have been separated and agglomerated by application of a magnetic field, and it is also relatively difficult to completely remove the nanoparticles such that the toxicity of the nanoparticles should be considered. Heat-sensitive dendrimers or magnetic nanoparticles coated with a hydrophilic polymer or a hydrophilic low molecular substance have a size of several nanometers or tens of nanometers so that they require the use of a nanofilter membrane or ultrafilter membrane. In addition, the redispersion of the aggregated polymer is relatively difficult.

### SUMMARY

Various embodiments relate to a draw solute that may generate a relatively high osmotic pressure, that shows a relatively low level of reverse salt flux, and that may be recovered and recycled with relative ease.

Various embodiments relate to a production method of the draw solute.

Various embodiments relate to forward osmosis water treatment devices and methods using an osmosis draw solution including the draw solute and water.

According to a non-limiting example embodiment, a draw solute may include a photosensitive oligomer. The photosensitive oligomer may include a first repeating unit and a second repeating unit. The first repeating unit may include a side chain having at least one functional group configured to trigger a photocrosslinking reaction. The second repeating unit may include an ionic moiety and a counter ion to the ionic moiety.

The photocrosslinking reaction may be reversible.

The functional group may be configured to undergo a 2+2 cycloaddition upon exposure to first electromagnetic waves to form a four-membered ring, and the four-membered ring may be converted again to the functional group via a retro-cycloaddition by second electromagnetic waves.

The first electromagnetic waves may be UV light of about 250 nm to 390 nm, and the second electromagnetic waves may be UV light of about 100 nm to about 290 nm.

The functional group may be a thymine moiety, a coumarin moiety, an anthracene moiety, or a combination thereof.

The photosensitive oligomer may include a polyamino acid main chain.

The ionic moiety of the second repeating unit may be an anionic moiety selected from —COO⁻, —SO₃⁻, —PO₃²⁻, and a combination thereof.

The second repeating unit may include identical ionic moieties or each may independently include a different ionic moiety.

The counter ion may be selected from an alkali metal cation, an alkaline earth metal cation, and a combination thereof.

The photosensitive oligomer may include the first repeating unit in an amount of greater than or equal to about 1 mol % and less than or equal to about 50 mol %.

The photosensitive oligomer may include the second repeating unit in an amount of greater than or equal to about 50 mol % and less than or equal to about 99 mol %.

The first repeating unit may be represented by Chemical Formula 1.

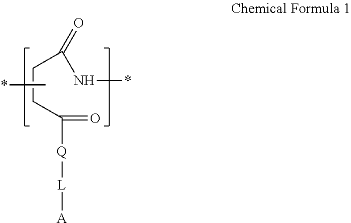

In Chemical Formula 1, Q is −NR—(wherein R is hydrogen or a C1 to C5 alkyl group) or —S—, L is a direct bond or a substituted or unsubstituted C1 to C20 alkylene, at least one methylene in the substituted or unsubstituted C1 to C20 alkylene may be replaced with an ester group (—COO—), a carbonyl group (—CO—), an ether group (—O—), or a combination thereof, A is represented by Chemical Formula 1-a, Chemical Formula 1-b, or Chemical Formula 1-c, and * is a portion that is linked to an adjacent repeating unit.

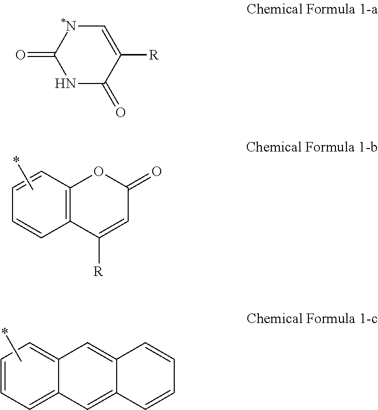

In Chemical Formulae 1-a to 1-c, * is a portion that is linked to L of Chemical Formula 1, the ring is unsubstituted or includes at least one substituent that does not affect the light-induced crosslinking addition, and R is a C1 to C10 alkyl group.

The second repeating unit may be represented by Chemical Formula 2.

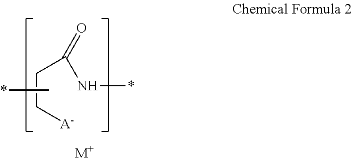

In Chemical Formula 2, A− is a group including an ionic moiety, M+ is a counter ion to the ionic moiety, and * is a portion that is linked to an adjacent repeating unit.

In the photosensitive oligomer, A−(s) of Chemical Formula 2 may be the same or different, and may be selected from —COO⁻, —CONR-Z-SO₃⁻, —CONR-Z-O—PO₃²⁻, —CO—S-Z-SO₃⁻, and —CO—S-Z—O—PO₃²⁻, wherein R is hydrogen or a C1 to C5 alkyl group, Z is a substituted or unsubstituted C1 to C20 alkylene, and M+ may be selected from Na⁺, K⁺, Li⁺, Ca²⁺, Mg²⁺, Ba²⁺, and a combination thereof.

Prior to the photocrosslinking reaction, the photosensitive oligomer may have a weight average molecular weight about 1000 g/mol to about 10,000 g/mol.

The photosensitive oligomer may show an increase of greater than or equal to about 100% in an average molecular weight after the photocrosslinking reaction.

Prior to the photocrosslinking reaction, a solution including the draw solute at a concentration of about 250 g/L may generate an osmotic pressure of greater than or equal to about 30 atm with respect to distilled water.

According to another example embodiment, a method of producing a draw solute including a photosensitive oligomer may include obtaining a succinimide oligomer; reacting the succinimide oligomer to open a portion (or parts) of succinimide rings in the succinimide oligomer to obtain a partially ring-opened product having at least one side chain having a coumarin moiety, a thymine moiety, or an anthracene moiety therein; and reacting the partially ring-opened product with an amine compound having an ionic moiety, a thiol compound having the ionic moiety, an inorganic base, or a combination thereof to open a remainder of the succinimide rings in the succinimide oligomer to introduce the ionic moiety and a counter ion thereto to form the photosensitive oligomer.

The photosensitive oligomer may include a first repeating unit (including at least one side chain having a coumarin moiety, a thymine moiety, or an anthracene moiety) and a second repeating unit (including an ionic moiety and a counter ion to the ionic moiety).

The amine compound having an ionic moiety may be an ester compound of a phosphoric acid and a C2 to C20 alkanolamine, a C2 to C20 sulfoalkyl amine, or a combination thereof, and the inorganic base may be an alkali metal hydroxide, an alkaline earth metal hydroxide, or a combination thereof.

According to another example embodiment, a forward osmosis method for water treatment may include contacting a feed solution (including water and materials to be separated being dissolved in the water) and a draw solution (including the aforementioned draw solute) with a semipermeable membrane positioned therebetween to obtain a treated solution including the water that moved from the feed solution to the draw solution through the semipermeable membrane by osmotic pressure; irradiating at least a portion of the treated solution with first electromagnetic waves to cause crosslinking between a photosensitive oligomer in the treated solution to obtain a crosslinked photosensitive oligomer in an irradiated solution; and removing the crosslinked photosensitive oligomer from the irradiated solution to obtain treated water.

The removing of the crosslinked photosensitive oligomer from the treated solution may include passing at least a portion of the treated water through an ultrafiltration membrane, a loose nanofiltration membrane, a microfiltration membrane, or a combination thereof.

The method may further include irradiating the crosslinked photosensitive oligomer removed from the treated solution with second electromagnetic waves and then introducing the same again into the draw solution.

According to another example embodiment of the present disclosure, a forward osmosis water treatment device may include a feed solution including water and materials to be separated being dissolved in the water; an osmosis draw solution including the aforementioned draw solute; a semipermeable membrane contacting the feed solution on one side and the osmosis draw solution on the other side; a recovery system configured to remove at least a portion of the draw solute from a treated solution including water that moved from the feed solution to the osmosis draw solution through the semipermeable membrane by osmotic pressure; and a connector configured to reintroduce the draw solute removed from the recovery system into the osmosis draw solution. The recovery system may include a first light irradiator that irradiates the treated solution with first electromagnetic waves of about 250 nm to about 390 nm, and the connector may include a second light irradiator that irradiates the draw solute removed from the recovery system with second electromagnetic waves of about 100 nm to about 290 nm.

The aforementioned draw solute may include a photosensitive oligomer that includes an ionic moiety and a counter ion thereto and, thus, may generate a relatively high level of osmotic pressure. In addition, the photosensitive oligomer included in the draw solute has an appropriate molecular weight and molecular structure so as to exhibit a relatively low reverse salt flux. Furthermore, when irradiated with electromagnetic waves, the photocrosslinkable functional groups of the photosensitive oligomer included in the draw solute may undergo a crosslinking reaction triggered by the irradiation of the electromagnetic waves, for example, in a reversible manner, and thereby the draw solute may be separated and recovered relatively easily (for example, by the use of a loose nanofiltration membrane or an ultrafiltration membrane) from the treated solution including the same and reused. Therefore, the energy cost for the recovery may be greatly reduced.

### BRIEF DESCRIPTION OF THE DRAWINGS

FIG. 1 is a schematic view of a forward osmosis water treatment device according to an example embodiment of the present disclosure.

FIG. 2 is a view schematically illustrating a reversible photo-crosslinking reaction of the photosensitive oligomer according to an example embodiment.

FIG. 3 is a view schematically illustrating a reversible photo-crosslinking reaction of the photosensitive oligomer according to another example embodiment.

FIG. 4 is a view schematically illustrating a reversible photo-crosslinking reaction of the photosensitive oligomer according to another example embodiment.

FIG. 5 shows a reaction scheme for synthesizing a photosensitive oligomer of Example 1.

FIG. 6 is a 1H-NMR analysis spectrum of the photosensitive oligomer synthesized in Example 1.

FIG. 7 shows a UV absorption spectroscopy analysis result of the photosensitive oligomer synthesized in Example 1.

FIG. 8 shows a reaction scheme for synthesizing a photosensitive oligomer of Example 2.

FIG. 9 shows a reaction scheme for synthesizing a photosensitive oligomer of Example 3.

### DETAILED DESCRIPTION

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As used herein, the term “substitute” refers to replacing one or more hydrogen atoms in a corresponding group (or moiety) with a hydroxyl group, a nitro group, a cyano group, an amino group, a carboxyl group, a linear or branched C1 to C30 alkyl group, a C1 to C10 alkyl silyl group, a C3 to C30 cycloalkyl group, a C6 to C30 aryl group, a C2 to C30 heteroaryl group, a C1 to C10 alkoxy group, a halogen, or a C1 to C10 fluoro alkyl group.

As used herein, the term “alkyl” of “alkylene” may include not only a linear or branched alkyl or alkylene, but also a cycloalkyl or cycloalkylene.

In an example embodiment, the draw solute may include a photosensitive oligomer including a first repeating unit and a second repeating unit. The first repeating unit may include a side chain having at least one functional group that may trigger a photocrosslinking reaction (hereinafter, also referred to as a photosensitive functional group). The second repeating unit may include an ionic moiety and a counter ion to the ionic moiety. The photosensitive functional group may trigger a photocrosslinking reaction in a reversible manner. The photosensitive oligomer may be a polyamino acid derivative. In other words, the photosensitive oligomer may include a polyamino acid main chain and thus may exhibit biocompatibility and biodegradability, holding a great potential in use as a draw solute for water purification. The photosensitive oligomer may include at least two different types of the first repeating unit and/or at least two different types of the second repeating unit.

As used herein, the term “a reversible photo-crosslinking reaction” refers to the reaction where a crosslinked bond formed by irradiation of a first light (or first electromagnetic waves) may be dissociated by irradiation of a second light (or second electromagnetic waves). In the reversible photo-crosslinking reaction, the molecular weight of the (crosslinked) oligomer being subject to the irradiation of the second light may be lower than the molecular weight of the oligomer prior to the irradiation of the second light. That is, the second light irradiation may bring forth a decrease in the molecular weight of the oligomer.

The photosensitive oligomer includes a photosensitive functional group in the first repeating unit. Such a functional group may provide crosslinking between the photosensitive oligomer chains upon exposure to the irradiation of first electromagnetic waves. The crosslinked photosensitive oligomer may show a higher molecular weight than the original oligomer prior to the crosslinking, and thus may be removed from a medium.

The photosensitive functional group may undergo a 2+2 cycloaddition triggered by first electromagnetic waves to form a four-membered ring. The first electromagnetic waves may have a wavelength of about less than or equal to about 400 nm, for example, about 250 nm to about 390 nm, about 300 nm to about 390 nm, or about 310 nm to about 365 nm. The oligomer including a four-membered, crosslinked ring may undergo a retro-cycloaddition reaction when it is irradiated with second electromagnetic waves, thereby reverting back to having at least one functional group capable of undergoing a reversible photo-crosslinking reaction. The second electromagnetic waves may have a wavelength of less than about 300 nm, for example, about 100 nm to about 290 nm, or about 180 nm to about 290 nm. The first electromagnetic waves and the second electromagnetic waves may be UV light, and their wavelengths may vary with the types of the functional group capable of conducting the (for example, reversible) photocrosslinking reaction. The functional group may be a thymine moiety, a coumarin moiety, an anthracene moiety, or a combination thereof. The foregoing functional groups are able to trigger a 2+2 cycloaddition reaction by the irradiation of the first electromagnetic waves to form a four-membered ring crosslinking between the oligomer chains.

In an example embodiment, the photosensitive oligomer may have a first repeating unit represented by Chemical Formula 1 and a second repeating unit represented by Chemical Formula 2.

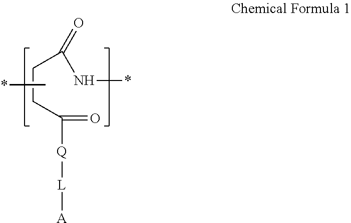

Herein, Q is —NR—(wherein R is hydrogen or a C1 to C5 alkyl group) or —S—, L is a direct bond or a substituted or unsubstituted C1 to C20 alkylene and at least one of methylene may be replaced with an ester group (—COO—) in the alkylene, a carbonyl group (—CO—), an ether group (—O—), or a combination thereof, A is represented by Chemical Formula 1-a, Chemical Formula 1-b, or Chemical Formula 1-c, and * is a portion that is linked to an adjacent repeating unit:

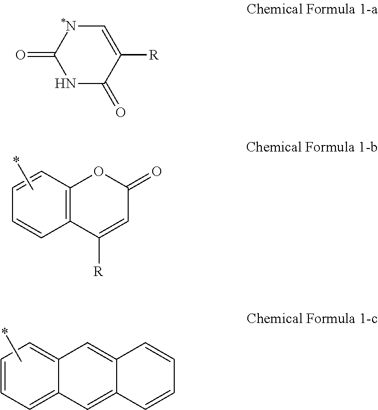

wherein * is a portion that is linked to L of Chemical Formula 1 and the ring is unsubstituted or includes at least one substituent that does not affect the light induced crosslinking addition and R is a C1 to C10 alkyl group;

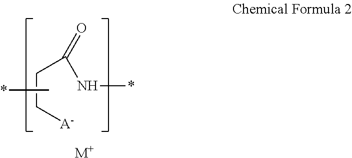

wherein A⁻ is a group including an ionic moiety, M⁺ is a counter ion to the ionic moiety, and * is a portion that is linked to an adjacent repeating unit.

Examples of the substituent not affecting the light-induced crosslinking addition may include, but are not limited to, a C1 to C10 alkyl group.

In the oligomer, A−(s) of Chemical Formula 2 may be the same or different and may be selected from —COO⁻, —CONR-Z-SO₃⁻, —CONR-Z-O—PO₃²⁻, —CO—S-Z-SO₃⁻, and —CO—S-Z-O—PO₃²⁻, wherein R is a hydrogen or a C1 to C5 alkyl group, Z is a substituted or unsubstituted C1 to C20 alkylene, and M+ may be selected from Na+, K+, Li+, Ca2+, Mg2+, Ba2+, and a combination thereof.

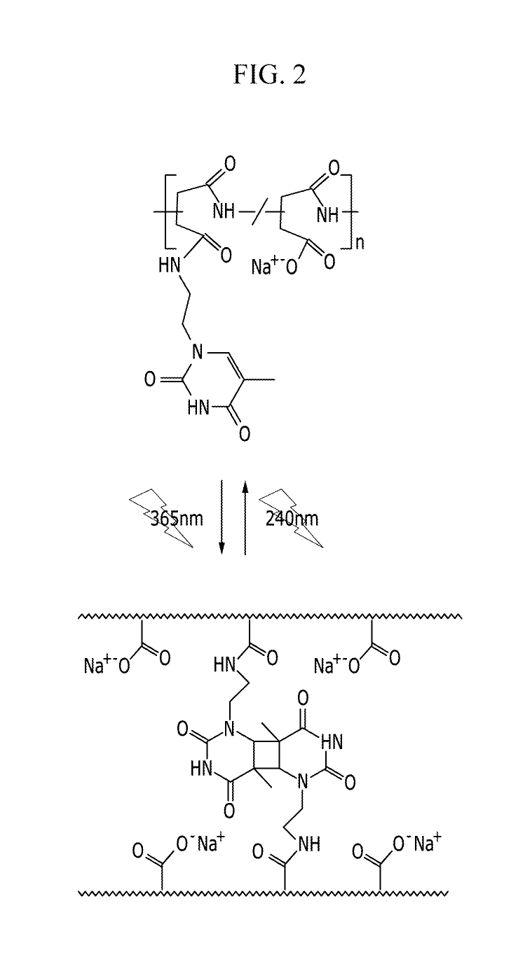

In non-limiting examples, referring to FIG. 2, when irradiated with UV light of less than or equal to about 400 nm (e.g., about 300 nm to about 390 nm), the photosensitive oligomer having a thymine moiety may undergo a 2+2 cycloaddition so as to be crosslinked. The resulting crosslinked oligomer may have a significantly increased molecular weight and thus may be separated relatively easily (for example, by using a loose nanofiltration membrane or an ultrafiltration membrane). The crosslinked oligomer may be converted again into the oligomer having the thymine moiety when it is irradiated with UV light of less than about 300 nm (e.g., about 180 nm to about 290 nm), and its molecular weight may be reduced to substantially the original value prior to being crosslinked.

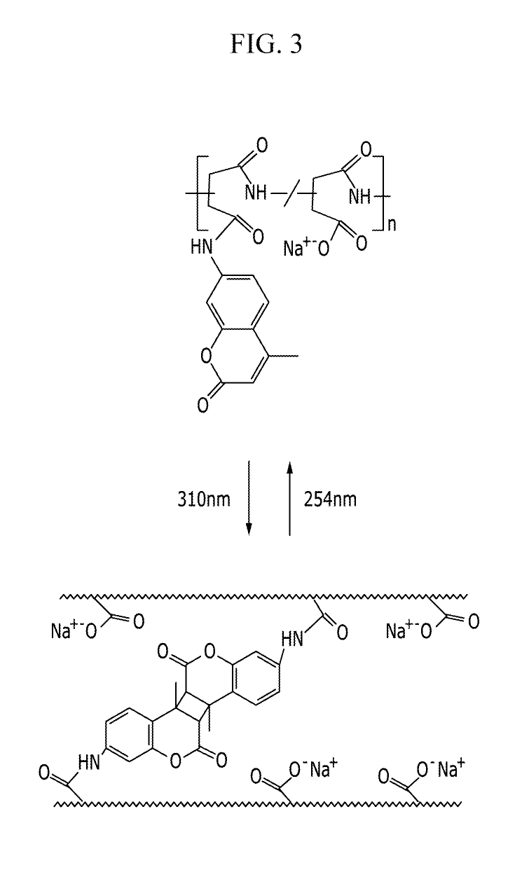

In non-limiting examples, referring to FIG. 3, when irradiated with UV light of less than or equal to about 315 nm (e.g., about 290 nm to about 310 nm), the photosensitive oligomer having a coumarin moiety represented by Chemical Formula 1-a may undergo a 2+2 cycloaddition so as to be crosslinked. The resulting crosslinked oligomer may have a significantly increased molecular weight and thus may be separated relatively easily. The crosslinked oligomer may be converted again into the oligomer having the coumarin moiety when it is irradiated with UV light of less than about 260 nm (e.g., about 240 nm to about 260 nm), and its molecular weight may be reduced to substantially the original value prior to being crosslinked.

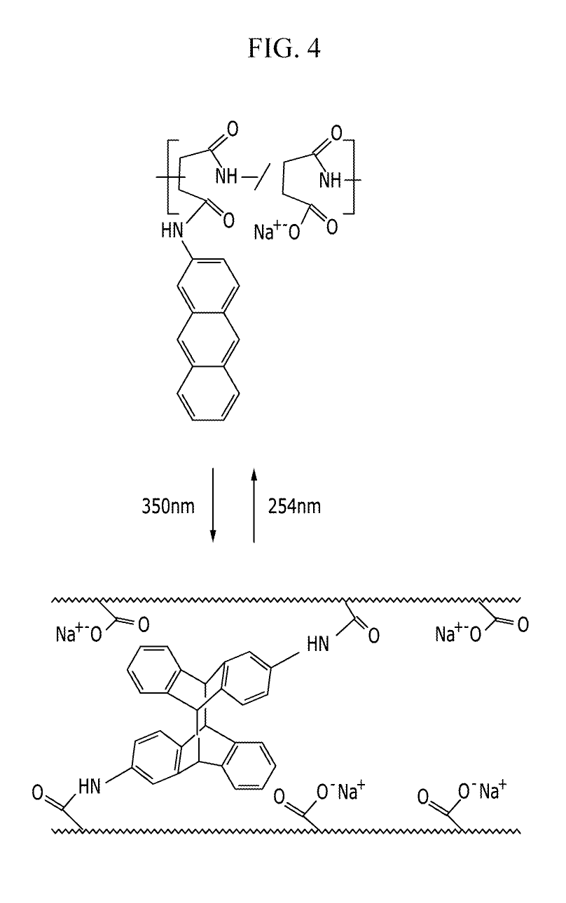

In non-limiting examples, referring to FIG. 4, when irradiated with UV light of less than or equal to about 380 nm (e.g., about 350 nm to about 370 nm), the photosensitive oligomer having an anthracene moiety may undergo a 2+2 cycloaddition so as to be crosslinked. The resulting crosslinked oligomer may have a significantly increased molecular weight and thus may be separated relatively easily. The crosslinked oligomer may be converted again into the oligomer having the anthracene moiety when it is irradiated with UV light of less than about 260 nm (e.g., about 230 nm to about 250 nm), and its molecular weight may be reduced to substantially the original value prior to being crosslinked.

In the photosensitive oligomer, examples of the ionic moiety of the second repeating unit may include —COO⁻, —SO₃⁻, —PO₃²⁻, or a combination thereof. The counter ion included in the second repeating unit carries a counter charge to the ionic moiety, and may be an alkali metal cation, an alkaline earth metal cation, or a combination thereof. The ionic moiety and the counter ion may be present in an ionically bonded state. In the photosensitive oligomer, the second repeating unit including the ionic moiety and the counter ions may impart ionicity to the oligomer. A plurality of the second repeating units may include an identical ionic moiety, or each of them may independently include an ionic moiety different from each other. That is, the oligomer may include one type of the ionic moiety, or it may include at least two types of the ionic moiety. In non-limiting examples, all the second repeating units of the photosensitive oligomer may include COO⁻ as the ionic moiety. In non-limiting examples, some of the second repeating units present in the photosensitive oligomer may include COO⁻ as the ionic moiety, and the others thereof may include —SO₃⁻ and/or —PO₃²⁻.

The ionicity may allow the photosensitive oligomer to exhibit a larger hydrodynamic volume and to have higher solubility in water, resulting in a higher osmotic pressure generated by the aqueous solution of the oligomer. Such effects may become more remarkable as the ionic radius of the counter ion decreases. The ionic moiety is included in the oligomer chain, and the counter ion may be confined to the ionic moiety (via an interaction such as an ionic bonding). Therefore, when being used as a draw solute, the photosensitive oligomer may induce higher osmotic pressure and keep the reverse draw solute diffusion at a minimum level.

In an example embodiment, prior to the photocrosslinking reaction, a solution including the photosensitive oligomer at a concentration of 250 g/L as a draw solute may generate high osmotic pressure of greater than or equal to about 30 atm, for example, greater than or equal to about 35 atm, or greater than or equal to about 40 atm.

The ratio (e.g., the molar ratio) between the first repeating unit and the second repeating unit may be controlled to optimize the photosensitivity (e.g., the changing rate of the molecular weight induced by the light irradiation) and the ionicity in the photosensitive oligomer. The molar ratio of the first repeating unit and the second repeating unit may be identified by the NMR analysis of the photosensitive oligomer. As the ratio of the first repeating unit increases, the photosensitivity becomes more significant and this may result in an easier separation process. As the ratio of the second repeating unit increases, the oligomer may generate higher osmotic pressure. In an example embodiment, the ratio between the first repeating unit and the second repeating unit of the photosensitive oligomer (the first repeating unit to the second repeating unit) may range from 1:1 to 1:99, for example, 1:1.5 to 1:50, or 1:2 to 1:30.

The photosensitive oligomer may be a block copolymer, a random copolymer, or a graft copolymer of the first repeating unit and the second repeating unit.

As stated above, the draw solute may include a photosensitive oligomer having not only the aforementioned photosensitive functional group but also the ionic moiety together with the counter ion thereto. Therefore, a draw solution including the draw solute may generate a relatively high osmotic pressure and the molecular weight of the oligomer allows the draw solute to be maintained at a relatively low level. In addition, in the draw solution diluted during a forward osmotic water treatment, the draw solute may include the crosslinked oligomer prepared by the irradiation of the electromagnetic waves of an appropriate wavelength. Therefore, the resulting crosslinked oligomer may be easily separated in a low energy separation process (e.g., using a loose nanofiltration membrane or an ultrafiltration membrane). That is, the separation of the draw solute may be easily accomplished without using a high energy consuming means (e.g., centrifugation, a reverse osmosis (RO) membrane, or a nanofiltration membrane). In addition, when the crosslinked oligomer as separated is irradiated with electromagnetic waves of an appropriate wavelength, the crosslinking bonds may be dissociated and the oligomer may show high osmotic pressure.

In an example embodiment, prior to undergoing the photocrosslinking reaction, the photosensitive oligomer may have a weight average molecular weight of about 1000 g/mol to 10,000 g/mol, for example, about 2000 g/mol to about 8000 g/mol. The photosensitive oligomer having a weight average molecular weight within the aforementioned range has a relatively high water solubility so that it may provide an aqueous solution of a high concentration. The prepared aqueous solution may generate a high level of osmotic pressure and thus may induce high water flux.

As stated above, the oligomer may form a crosslinking bond by the irradiation of the light so as to have a higher molecular weight, and thus may be separated easily through a low energy process. When the crosslinked oligomer is irradiated with the second electromagnetic waves, the crosslinking bond may be easily dissociated and the oligomer may be reused as the draw solute. The photosensitive oligomer may show a molecular weight increase of 30% or higher, for example at least about 50%, at least about 100%, at least about 150%, or at least about 200%. With the increase of the molecular weight, the photosensitive (crosslinked) oligomer obtained after the photocrosslinking reaction may exhibit increased polydispersity.

In another example embodiment, a method of producing a draw solute including the aforementioned photosensitive oligomer may include obtaining a succinimide oligomer; reacting the succinimide oligomer to open some of the succinimide rings in the succinimide oligomer to obtain a partially ring-opened product having at least one side chain including a coumarin moiety, a thymine moiety, or an anthracene moiety therein; and reacting the partially ring-opened product with an amine compound having an ionic moiety, a thiol compound having an ionic moiety, an inorganic base, or a combination thereof to open the succinimide rings remaining in the succinimide oligomer to introduce the ionic moiety and a counter ion thereto to form the photosensitive oligomer.

The succinimide oligomer may have a number average molecular weight of less than about 10,000 g/mol, less than about 9000 g/mol, for example about 500 g/mol to about 8000 g/mol, about 1000 g/mol to about 5000 g/mol, or about 2000 g/mol to about 3000 g/mol, but it is not limited thereto. In an example embodiment, the succinimide oligomer may have a number average molecular weight of equal to or less than 8000. The succinimide oligomer having such molecular weight may be prepared by any suitable methods known in the art or is commercially available.

The opening of some succinimide rings of the succinimide oligomer may be carried out by subjecting the succinimide oligomer to a ring opening reaction with the amine compound or a thiol compound in a solvent. The types of the solvent are not particularly limited so long as the solvent may dissolve the succinimide oligomer and the amine compound or the thiol compound without triggering a side reaction with the amine or thiol group. Specific examples of the solvent may include, but are not limited to, N,N-dimethylformamide (DMF), dimethyl sulfoxide (DMSO), dimethylacetamide (DMAc), and sulfolane. The temperature and the time for the ring opening reaction are not particularly limited, and may be appropriately selected. For example, the ring opening reaction may be carried out at a temperature of about 50° C. to about 100° C., specifically about 60° C. to about 90° C., and more specifically about 70° C. to about 80° C., for about 3 hours to about 72 hours. The ring opening reaction may be conduced in the presence of triethyl amine, triethanol amine, pyridine, or a combination thereof.

In an example embodiment, the amine compound or the thiol compound may include at least one of the aforementioned photosensitive functional groups (e.g., a thymine moiety, a coumarin moiety, and/or an anthracene moiety). In this case, the ring opening reaction of the succinimide oligomer with the amine compound or the thiol compound may produce a partially ring opened product having at least one side chain including the coumarin moiety, the thymine moiety, or the anthracene moiety.

Alternatively, the amine compound or the thiol compound may have a functional group that may react with a compound having the aforementioned photosensitive functional group (e.g., a substituted or unsubstituted thymine, a substituted or unsubstituted coumarin, or a substituted or unsubstituted anthracene, hereinafter also referred to as “a photosensitive compound”). Examples of these compounds may include, but are not limited to, a haloalkyl amine such as bromoethylamine, chloroethylamine, and a haloalkyl thiol. The obtained products of such a ring opening reaction is subjected to a reaction with the photosensitive compound to produce a ring opened product having at least one introduced side chain having a coumarin moiety, a thymine moiety, or an anthracene moiety. Reaction conditions such as reaction temperature, time, a solvent, and the like may depend on the types of the compound being used, and are not particularly limited.

The ring opened product is subject to a reaction with an amine compound having an ionic moiety, a thiol compound having an ionic moiety, an inorganic base, or a combination thereof. The reaction opens the remaining succinimide ring in the succinimide oligomer and introduces the ionic moiety and the counter ions into the oligomer. Examples of the amine compound having an ionic moiety may include, but are not limited to, an ester compound of a phosphoric acid and a C1 to C20 alkanolamine (e.g., orthophosphoethanolamine), and a C1 to C20 sulfoalkyl amine such as aminoethanesulfonic acid. Examples of the inorganic base may include, but are not limited to, an alkali metal hydroxide such as NaOH, KOH, and LiOH, and an alkaline earth metal hydroxide such as CaOH, MgOH, and BaOH.

The photosensitive oligomer may be used as an osmotic draw solute in a forward osmotic water treatment process. Details of the photosensitive oligomer may be the same as set forth above. In the forward osmotic water treatment process, a osmotic draw solution having a higher concentration than that of the feed solution is used to move water molecules from the feed solution to the draw solution. Then, the draw solute is separated from the resulting draw solution to produce fresh water. The separated draw solute may be used again. The forward osmotic water treatment process may be operated at a lower cost than a reverse osmotic process, which is a pressure driven process. However, the absence of an appropriate draw solution has hampered the practical use of the forward osmotic process. The photosensitive oligomer having the aforementioned structure may generate a high level of osmotic pressure in the aqueous solution. In addition, as the photosensitive oligomer has a polyamino acid main chain and the ionic moiety and the counter ions thereto, it may exhibit biodegradability and biocompatibility (e.g., low biotoxicity), and thus hold great potential for use in the process of preparing drinking water or water for general living.

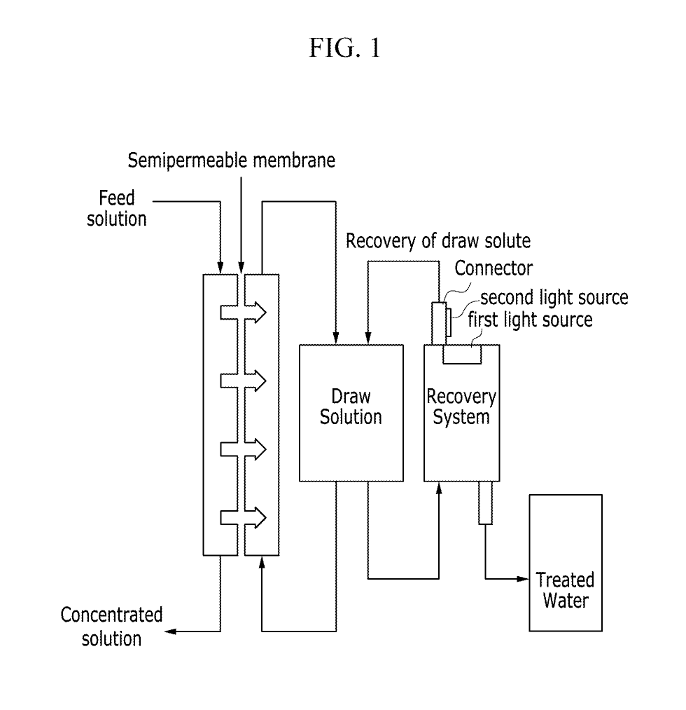

According to another example embodiment of the present disclosure, a forward osmosis water treatment device including a draw solution containing the aforementioned photosensitive oligomer is provided. The forward osmosis water treatment device may include a feed solution including water and materials to be separated being dissolved in the water; the aforementioned osmosis draw solution; a semipermeable membrane contacting the feed solution on one side and the osmosis draw solution on the other side; a recovery system configured to remove the photosensitive oligomer from a treated solution including water that moved from the feed solution to the osmosis draw solution through the semipermeable membrane by osmotic pressure; and a connector configured to reintroduce the photosensitive oligomer removed from the recovery system to the osmosis draw solution. The recovery system may include a first light irradiator that irradiates the treated solution with first electromagnetic waves of 400 nm or less. The connector may include a second light irradiator that irradiates the draw solute removed from the recovery system with second electromagnetic waves of 300 nm or less. FIG. 1 shows a schematic view of a forward osmosis water treatment device according to an example embodiment that may be operated by the forward osmosis water treatment method that will be explained hereinafter.

The semipermeable membrane is permeable to water and non-permeable to the materials to be separated. The types of the feed solution are not particularly limited as long as they may be treated in the forward osmosis manner. The materials to be separated may be impurities. Specific examples of the feed solution may include, but are not limited to, sea water, brackish water, ground water, waste water, and the like. By way of a non-limiting example, the forward osmosis water treatment device may treat sea water to produce drinking water.

Details for the photosensitive oligomer may be the same as set forth above. The concentration of the osmosis draw solution may be controlled to generate higher osmotic pressure than that of the feed solution. By way of an example, the photosensitive oligomers may generate osmotic pressure of at least 40 atm with respect to distilled water when they are dissolved at a concentration of about 250 mg/mL in distilled water. However, the concentration of the osmosis draw solution and the osmotic pressure generated therefrom may vary with the structure of the copolymer, the types of the feed solution, and the like.

In the recovery system, the removal of the photosensitive oligomer may utilize the photosensitivity of the oligomer. The recovery system may be provided with a light source that is configured to irradiate the treated solution with first electromagnetic waves having a desired wavelength. Such a light source is commercially available. In the recovery system, the location of the light source may be selected appropriately in light of the shape of the recovery system and the volume of the treated solution. The light source may be easily mounted to most types of recovery system. The irradiation of the first electromagnetic wave may be accomplished in a far simpler and effective manner than the means of using other energy (e.g., heat energy). The first electromagnetic waves may be UV light having the aforementioned wavelength, and this makes it possible to carry out UV sterilization of the treated solution at the same time. In this respect, the aforementioned apparatus may be particularly advantageous for the production of drinking water or water for general household use. The oligomer in the treated solution irradiated with the electromagnetic wave may be crosslinked and thus may be easily filtered and separated. The recovery system may include a microfiltration membrane, an ultrafiltration membrane, a loose nanofiltration membrane, or a centrifuge in order to filter or separate the draw solute including the crosslinked oligomer from the treated solution irradiated with the electromagnetic waves.

The draw solute as removed may be introduced into the draw solution again via the connector. The connector may further include a light source irradiating the draw solute including the crosslinked oligomer with second electromagnetic waves. The light source is commercially available, and the location of the light source in the connector is not particularly limited. The second electromagnetic waves may have a wavelength within the aforementioned range.

The forward osmosis water treatment device may further include an outlet for discharging treated water produced by removing the photosensitive oligomer from the treated solution in the recovery system. The types of the outlet are not particularly limited.

In yet another example embodiment of the present disclosure, a forward osmosis method for water treatment may include contacting a feed solution (including water and materials to be separated being dissolved in the water) and a draw solution (including the aforementioned draw solute) with a semipermeable membrane positioned therebetween to obtain a treated solution including water that moved from the feed solution to the draw solution through the semipermeable membrane by osmotic pressure; irradiating at least a portion of the treated solution with first electromagnetic waves having a wavelength of about 400 nm or lower to cause crosslinking of the photosensitive oligomer in the treated solution; and removing the crosslinked photosensitive oligomer from the treated solution to obtain treated water. The method may further include discharging the treated water. The method may further include irradiating the removed photosensitive oligomer with second electromagnetic waves and introducing the same again to the draw solution.

When the feed solution and the draw solution are brought into contact with the semipermeable membrane disposed therebetween, water in the feed solution is driven to move through the semipermeable membrane into the osmosis draw solution by osmotic pressure.

The photosensitive oligomer, the semipermeable membrane, the forward osmosis process, the irradiation of the draw solute, and the separation of the crosslinked oligomer may be the same as set forth above.

The removing of the crosslinked photosensitive oligomer from the treated solution may include passing at least a portion of the treated solution through an ultrafiltration membrane, a loose nanofiltration membrane, a microfiltration membrane, or a combination thereof.

Hereinafter, various embodiments are illustrated in more detail with reference to the following examples. However, it should be understood that the following are example embodiments and are not intended to be limiting.

### EXAMPLES

### Example 1

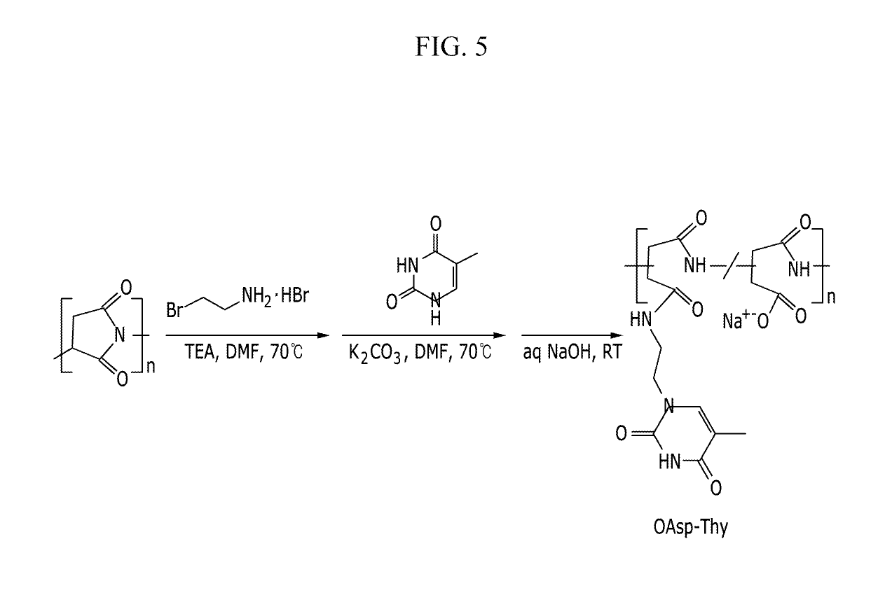

An aspartic oligomer containing a thymine moiety is synthesized via the Reaction Scheme of FIG. 5.

10 g of a succinimide oligomer (hereinafter, PSI, molecular weight: 2000 to 3000, purchased from Bayer Co. Ltd.) is dissolved in a mixture of dimethylformamide (DMF), and 0.5 mL of triethylamine and 6.1 g of bromoethyl hydrobromide (purchased from Sigma Aldrich Co. Ltd.) is added thereto. The resulting solution is heated to 70° C. and reacted for 24 hours. 4.54 g of thymine (purchased from Sigma Aldrich Co. Ltd.) and potassium carbonate (K2CO₃, purchased from Sigma Aldrich Co. Ltd.) are added to the reaction product, and the resulting mixture is heated again to 70° C. and reacted for 24 hours to obtain a solution containing a partially ring opened product having a thymine moiety introduced thereto. 2.8 g of sodium hydroxide (purchased from Yakuri Pure Chemicals Co. LTD.) is added to the resulting solution and stirred at room temperature for 30 minutes. The reacted solution thus obtained is dialyzed against methanol for 48 hours, and then against water for 48 hours, to produce a liquid product, which is then subjected to freeze-drying to obtain a powder product.

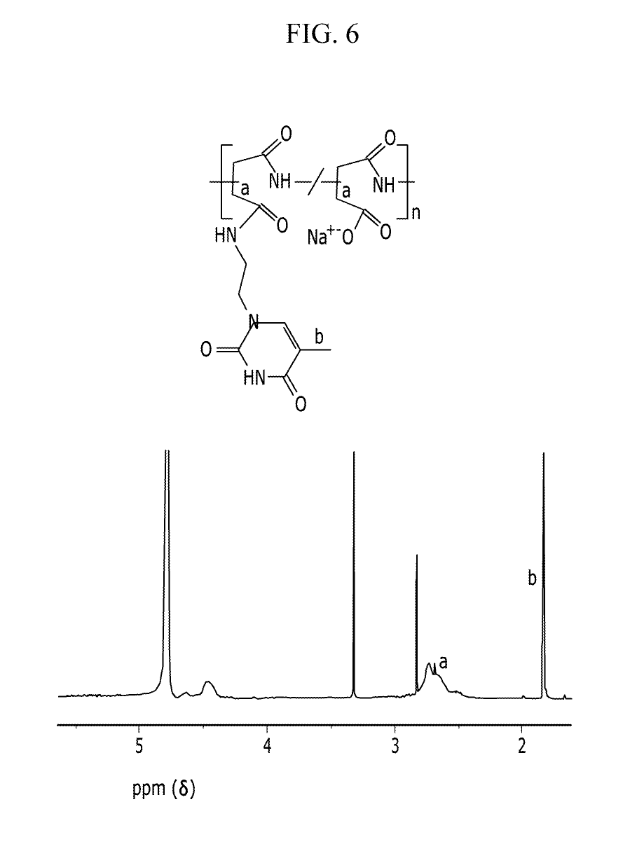

FIG. 6 shows a 1H-NMR spectrum of the synthesized oligomer. The results of FIG. 6 confirm that the photosensitive oligomer having the chemical formula shown in FIG. 5 is obtained.

### Example 2

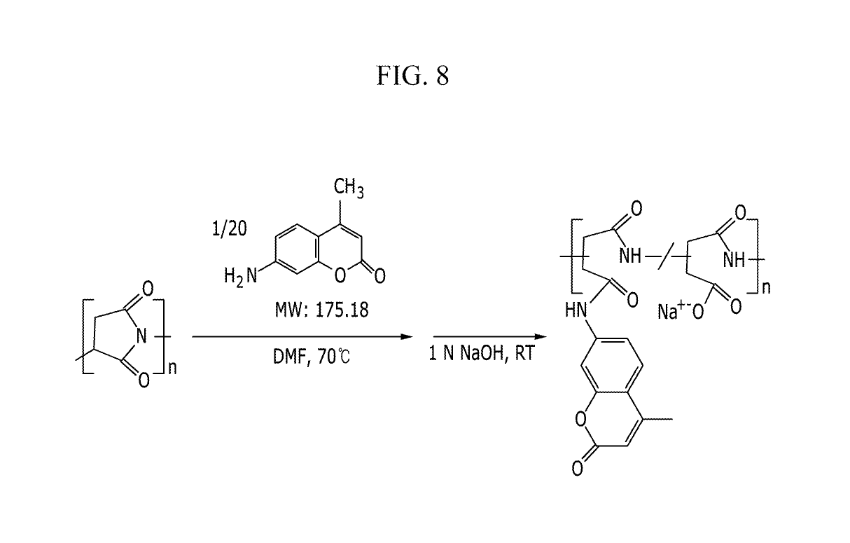

An aspartic acid oligomer containing a coumarin moiety is synthesized in accordance with the reaction scheme of FIG. 8.

0.45 g of 7-amino-4-methylcoumarin (purchased from Sigma-Aldrich Co. Ltd.) is dissolved in 2.5 mL of dimethyl sulfoxide (DMSO) (purchased from Sigma-Aldrich Co. Ltd.) to obtain a coumarin solution. 5 g of PSI is dissolved in 10 mL of DMSO in a reactor, the coumarin solution is added to the reactor, and then 0.8 mL of triethylamine (purchased from Sigma-Aldrich Co. Ltd.) is added thereto and a reaction proceeds at 70° C. for 24 hours.

125 mL of a NaOH aqueous solution (1.95 g of NaOH, purchased from Sigma-Aldrich Co. Ltd.) is added to the resulting solution, which is then reacted at room temperature for another 12 hours. After the completion of the reaction, methanol (purchased from Sigma-Aldrich Co. Ltd.) is added to form a precipitate, which is then subjected to centrifuge. The separated product is vacuum dried at a temperature of 100° C.

### Example 3

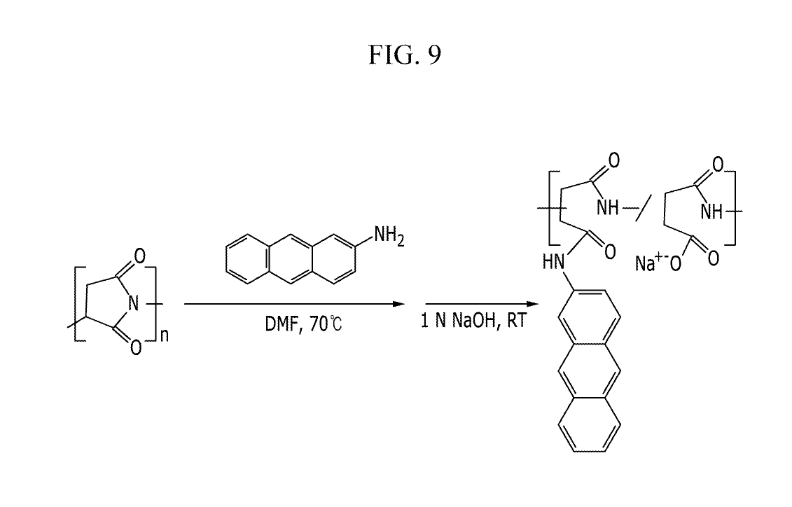

An aspartic acid oligomer containing an anthracene moiety is synthesized in accordance with the reaction scheme of FIG. 9.

0.5 g of 2-aminoanthracene (purchased from Sigma-Aldrich Co. Ltd.) is dissolved in 2.5 mL of dimethyl sulfoxide (DMSO) (purchased from Sigma-Aldrich Co. Ltd.) to obtain an aminoanthracene solution. 5 g of PSI is dissolved in 10 mL of DMSO in a reactor, the coumarin solution is added to the reactor, and then 0.8 mL of triethylamine (purchased from Sigma-Aldrich Co. Ltd.) is added thereto and a reaction proceeds at 70° C. for 24 hours.

125 mL of a NaOH aqueous solution (1.95 g of NaOH, purchased from Sigma-Aldrich Co. Ltd.) is added to the resulting solution, and reacted at room temperature for another 12 hours. After the completion of the reaction, methanol (purchased from Sigma-Aldrich Co. Ltd.) is added to form a precipitate, which is then subjected to centrifuge. The separated product is vacuum dried at a temperature of 100° C.

### Comparative Example 1

0.97 g (10 mmol) of polysuccinimide (PSI) (purchased from Bayer Co. Ltd., number average molecular weight: 2000-3000) is added to a 1 M NaOH solution and stirred for 3 hours. The reaction product is precipitated in methanol, and then is subjected to centrifuge and vacuum-drying to prepare an aspartic oligomer (OAsp).

### Comparative Example 2

MgSO₄ (Mw: 120.37) is purchased from Sigma Aldrich, Co., Ltd.

### Experimental Example 1

### Photocrosslinkinq of the Oligomers (Confirmed by Changes in UV Absorbency)

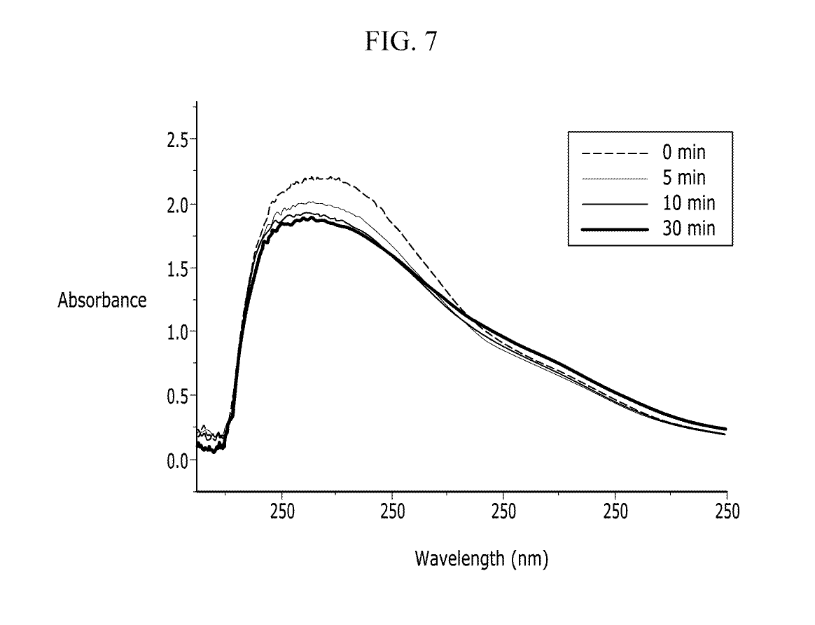

The photosensitive oligomer containing a thymine moiety prepared from Example 1 is dissolved in distilled water at a concentration of 0.5 g/L to prepare an aqueous solution. The aqueous solution is irradiated with light of a 365 nm wavelength at an intensity of 8.96 mW/cm² for a predetermined time, and the absorbance of the aqueous solution is measured using a UV detector (CBM-20A, Shimadzu). The results are shown in FIG. 7. From the results of FIG. 7, as the light irradiation time increases, the characteristic UV absorbance peak of the thymine decreases.

The 30 minute irradiated solution obtained as above is irradiated with light of a 240 nm wavelength at an intensity of 8 mW/cm² for 30 minutes, and its absorbance is measured using the UV detector (CBM-20A, from Shimadzu). The results confirm that the characteristic UV absorbance peak of the thymine increases again.

### Experimental Example 2

### Photocrosslinkinq of the oligomers (Confirmed by Changes in Molecular Weight)

The photosensitive oligomer of Example 1 and the oligomer of Comparative Example 1 are subjected to a gel permeation chromatographic analysis to determine their weight average molecular weight and polydispersity. The results are summarized in Table 1.

The aqueous solutions of the oligomer of Example 1 and the oligomer of Comparative Example 1 (concentration: 0.5 g/L) are irradiated with light of a 365 nm wavelength (at an intensity of 8 mW/cm²), respectively, and the irradiated aqueous solutions are subjected to the gel permeation chromatographic analysis to determine a weight average molecular weight and polydispersity. The results are summarized in Table 1.

TABLE 1

| | | Prior to UV | After UV |
|---|---|---|---|
| | | irradiation | irradiation |
| Example 1 | Mw | 4567 | 19,496 |
| | PDI | 1.28 | 1.58 |
| Comparative | Mw | 2836 | 2836 |
| Example 1 | | | |
| | PDI | 1.16 | 1.16 |

The results of Table 1 confirm that the oligomer of Example 1 shows a molecular weight increase of 400% by UV light irradiation, while the oligomer of Comparative Example 1 shows no increase by the UV light irradiation.

### Experimental Example 3

### Preparation of The Osmosis Draw Solution

Osmosis draw solutions including the photosensitive oligomer of Example 1 at various concentrations set forth in Table 2 are prepared. For each of the draw solutions, osmotic pressure analysis is made using an osmotic pressure meter (Osmomat 090, Gonotek) in accordance with a membrane measurement method. The results are compiled in Table 2.

Each of the draw solutions is irradiated with light of a 365 nm wavelength (at an intensity of 8 mW/cm2) for 30 minutes, and then its osmotic pressure is measured in accordance with the aforementioned method. The results are compiled in Table 2.

Osmosis draw solutions including the oligomer of Comparative Example 1 and the polyvalent salt of Comparative Example 2 are prepared at various concentrations set forth in Table 3. For each of the draw solutions, osmotic pressure analysis is made using an osmotic pressure meter (Osmomat 090, Gonotek) in accordance with a membrane measurement method. The results are compiled in Table 3.

TABLE 2

| | Prior to UV irradiation | | After UV irradiation | |
|---|---|---|---|---|
| | | Osmotic | | Osmotic |
| Concentration | Osmolality | pressure | Osmolality | pressure |
| (mg/ml) | (Osmol/kg) | (atm) | (Osmol/kg) | (atm) |
| 50 | 0.257 | 6.28 | 0.212 | 5.18 |
| 100 | 0.448 | 10.94 | 0.345 | 8.43 |
| 150 | 0.784 | 19.15 | 0.575 | 14.05 |
| 200 | 1.224 | 29.91 | 0.887 | 21.67 |
| 250 | 1.717 | 41.95 | 1.327 | 32.43 |
| 300 | 2.324 | 56.79 | — | — |

TABLE 3

| Comparative Example 1 | | | Comparative Example 2 | | |
|---|---|---|---|---|---|
| Concen- | | Osmotic | Concen- | | Osmotic |
| tration | Osmolality | pressure | tration | Osmolality | pressure |
| (mg/ml) | (Osmol/kg) | (atm) | (mg/ml) | (Osmol/kg) | (atm) |
| 41.03 | 0.209 | 5.11 | 30.09 | 0.295 | 7.209 |
| 65.65 | 0.338 | 8.27 | 36.11 | 0.352 | 8.610 |
| 82.06 | 0.441 | 10.78 | 48.15 | 0.460 | 11.232 |
| 131.30 | 0.736 | 17.99 | 60.19 | 0.572 | 13.977 |
| 164.13 | 1.008 | 24.64 | 120.37 | 1.290 | 31.514 |
| 262.6 | 2.009 | 49.08 | 180.56 | 2.525 | 61.693 |

The results of Table 2 confirm that the draw solution may show high osmotic pressure prior to the UV irradiation, while its osmotic pressure may slightly decrease after the UV irradiation. The results of Table 3 confirm that the draw solutes of Comparative Example 1 and 2 may generate high osmotic pressure and their osmotic pressures are not changed after the UV irradiation.

### Experimental Example 4

### Recovery Tests for the Draw Solute

Osmosis draw solutions including the photosensitive oligomer of Example 1 is irradiated with light of a 365 nm wavelength for 30 minutes, and the recovery test is conducted using an ultrafiltration membrane (Millipore Ultrafiltration membrane, MWCO 10,000). The recovery rates are shown in Table 4. The same recovery tests are made for osmosis draw solutions including the oligomer of Comparative Example 1 and the polyvalent salt of Comparative Example 2. The recovery rates are shown in Table 4.

TABLE 4

| | Recovery rate (%) | |
|---|---|---|
| Example 1 | Prior to UV irradiation | After UV irradiation |
| | 21.4 | 98.7 |

| | |
|---|---|
| Comp. Example 1 | 17.8 |
| Comp. Example 2 | Recovery impossible |

The results of Table 4 confirm that the draw solute of Example 1 may exhibit a relatively high recovery rate when irradiated with UV light, while the draw solutes of Comparative Examples 1 and 2 show a relatively low recovery rate or are impossible to be recovered by using the ultrafiltration membrane.

While various example embodiments are disclosed herein, it is to be understood that the present disclosure is not limited to the disclosed embodiments, but, on the contrary, is intended to cover various modifications and equivalent arrangements included within the spirit and scope of the appended claims.

What is claimed is:

1. A draw solute comprising:
a photosensitive oligomer including a first repeating unit and a second repeating unit, the first repeating unit including a side chain having at least one functional group configured to undergo a photocrosslinking reaction, the second repeating unit including an ionic moiety and a counter ion to the ionic moiety.

2. The draw solute of claim 1, wherein the photosensitive oligomer is a polyamino acid derivative.

3. The draw solute of claim 1, wherein the at least one functional group is configured to undergo a 2+2 cycloaddition to form a four-membered ring upon exposure to first electromagnetic waves, the four-membered ring configured to be converted back to the at least one functional group via a retro-cycloaddition upon exposure to second electromagnetic waves.

4. The draw solute of claim 3, wherein the first electromagnetic waves are UV light of a wavelength from 250 nm to 390 nm, and the second electromagnetic waves are UV light of a wavelength from 100 nm to 290 nm.

5. The draw solute of claim 1, wherein the at least one functional group is a thymine moiety, a coumarin moiety, an anthracene moiety, or a combination thereof.

6. The draw solute of claim 1, wherein the photosensitive oligomer includes a polyamino acid main chain.

7. The draw solute of claim 1, wherein the ionic moiety of the second repeating unit includes an anionic moiety selected from —COO⁻, —SO₃⁻, —PO₃²⁻, and a combination thereof.

8. The draw solute of claim 1, wherein the counter ion is selected from an alkali metal cation, an alkaline earth metal cation, and a combination thereof.

9. The draw solute of claim 1, wherein the first repeating unit is present in an amount of greater than or equal to about 1 mol % and less than or equal to about 50 mol %, and the second repeating unit is present in an amount of greater than or equal to about 50 mol % and less than or equal to about 99 mol %.

10. The draw solute of claim 1, wherein the first repeating unit is represented by Chemical Formula 1: 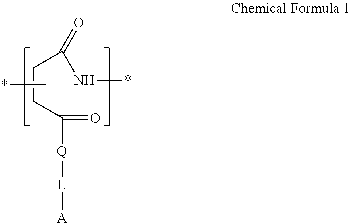
wherein, in Chemical Formula 1, Q is —NR—(wherein R is hydrogen or a C1 to C5 alkyl group) or —S—, L is a direct bond or a substituted or unsubstituted C1 to C20 alkylene, at least one methylene in the substituted or unsubstituted C1 to C20 alkylene may be replaced with an ester group (—COO—), a carbonyl group (—CO—), an ether group (—O—), or a combination thereof, A is represented by Chemical Formula 1-a, Chemical Formula 1-b, or Chemical Formula 1-c, and * is a portion that is linked to an adjacent repeating unit: 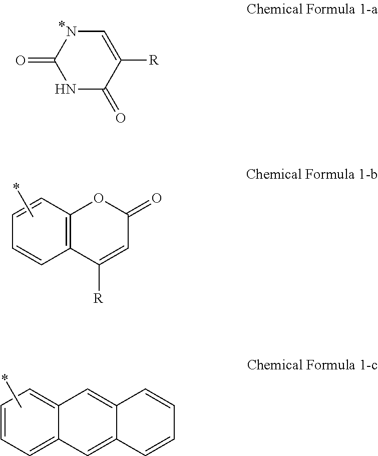
wherein, in Chemical Formulae 1-a to 1-c, * is a portion that is linked to L of Chemical Formula 1, a ring in Chemical Formulae 1-a to 1-c is unsubstituted or includes at least one substituent that does not affect a light-induced crosslinking addition, and R is a C1 to C10 alkyl group; and
the second repeating unit is represented by Chemical Formula 2: 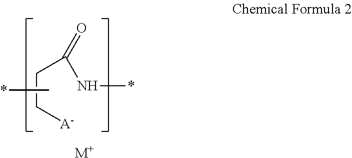
wherein, in Chemical Formula 2, A⁻ is a group including the ionic moiety, M⁺ is the counter ion to the ionic moiety, and * is a portion that is linked to an adjacent repeating unit.

11. The draw solute of claim 1, wherein the photosensitive oligomer has a weight average molecular weight of about 1000 g/mol to about 10,000 g/mol prior to the photocrosslinking reaction.

12. The draw solute of claim 1, wherein the photosensitive oligomer is configured to undergo an increase of greater than or equal to about 100% in an average molecular weight after the photocrosslinking reaction.

13. The draw solute of claim 1, wherein the draw solute is configured such that, prior to the photocrosslinking reaction, a solution including the draw solute at a concentration of about 250 g/L generates an osmotic pressure of greater than or equal to about 30 atm with respect to distilled water.

14. A method of producing a draw solute including a photosensitive oligomer, the method comprising:
reacting a succinimide oligomer to open a portion of succinimide rings in the succinimide oligomer to obtain a partially ring-opened product having at least one side chain having a coumarin moiety, a thymine moiety, or an anthracene moiety therein; and
reacting the partially ring-opened product with an amine compound having an ionic moiety, a thiol compound having the ionic moiety, an inorganic base, or a combination thereof to open a remainder of the succinimide rings in the succinimide oligomer to introduce the ionic moiety and a counter ion thereto to form the photosensitive oligomer, the photosensitive oligomer including a first repeating unit and a second repeating unit, the first repeating unit including at least one side chain having the coumarin moiety, the thymine moiety, or the anthracene moiety, the second repeating unit including the ionic moiety and the counter ion to the ionic moiety.

15. The method of claim 14, wherein the photosensitive oligomer has a weight average molecular weight of less than or equal to about 10,000 g/mol.

16. The method of claim 14, wherein the amine compound having an ionic moiety includes an ester compound of a phosphoric acid and a C2 to C20 alkanolamine, a C2 to C20 sulfoalkyl amine, or a combination thereof, and the inorganic base includes an alkali metal hydroxide, an alkaline earth metal hydroxide, or a combination thereof.

17. A forward osmosis water treatment method, comprising:
contacting a feed solution and a draw solution with a semipermeable membrane positioned therebetween to obtain a treated solution, the feed solution including water and materials to be separated dissolved in the water, the draw solution including the draw solute of claim 1, the treated solution including water that moved from the feed solution to the draw solution through the semipermeable membrane by osmotic pressure;
irradiating at least a portion of the treated solution with first electromagnetic waves of about 250 nm to about 390 nm to cause crosslinking between a photosensitive oligomer in the treated solution to obtain a crosslinked photosensitive oligomer in an irradiated solution; and
removing the crosslinked photosensitive oligomer from the irradiated solution to obtain treated water.

18. The forward osmosis water treatment method of claim 17, wherein the removing the crosslinked photosensitive oligomer from the irradiated solution includes passing at least a portion of the treated water through a microfiltration membrane.

19. The forward osmosis water treatment method of claim 17, further comprising:
irradiating the crosslinked photosensitive oligomer removed from the irradiated solution with second electromagnetic waves of about 100 nm to about 290 nm to reverse the crosslinking caused by the first electromagnetic waves and revert the crosslinked photosensitive oligomer back to the photosensitive oligomer; and
introducing the photosensitive oligomer back into the draw solution.

20. A forward osmosis water treatment device, comprising:
a feed solution including water and materials to be separated dissolved in the water;
an osmosis draw solution including the draw solute of claim 1;
a semipermeable membrane having a first side and an opposing second side, the first side configured to contact the feed solution, the opposing second side configured to contact the osmosis draw solution;
a recovery system configured to remove at least a portion of the draw solute from a treated solution including water that moved from the feed solution to the osmosis draw solution through the semipermeable membrane by osmotic pressure, the recovery system including a first light irradiator configured to irradiate the treated solution with first electromagnetic waves of about 250 nm to about 390 nm; and
a connector configured to reintroduce the draw solute from the recovery system into the osmosis draw solution, the connector including a second light irradiator configured to irradiate the draw solute from the recovery system with second electromagnetic waves of about 100 nm to about 290 nm.
